(19) United States
(12) Patent Application Publication
(10) Pub. No.: US 2026/0356135 A1
(43) Pub. Date: Nov. 12, 2026

(54) VEHICLE WHEEL PROVIDED WITH AN ASSEMBLY FOR ADJUSTING AIR PRESSURE

(71) Applicant: STELLANTIS EUROPE S.P.A., TORINO (IT)

(72) Inventors: Renato BADINO, Torino (IT); Luigi PETRUCCELLI, Torino (IT); Silvano SANDRI, Torino (IT); Alessandro BECCHERI, Torino (IT); Oreste BERTINI, Torino (IT)

(21) Appl. No.: 19/489,753

(22) PCT Filed: Jun. 4, 2024
(86) PCT No.: PCT/IB2024/055443

§ 371 Date: Dec. 3, 2025

(30) Foreign Application Priority Data
Jun. 6, 2023 (IT) 102023000011493

(51) Int. Cl. B60C 23/00

(52) U.S. Cl. CPC B60C 23/004

(57) ABSTRACT

A vehicle wheel has a rim, a tire, a chamber, which is filled with air and can be pressurized, and an assembly for adjusting the air pressure in said chamber; the assembly has at least one compressor pneumatically connected to the chamber, at least one reservoir carried by the rim and pneumatically connected to the compressor to receive compressed air, at least one battery to supply electric power, and at least one solenoid valve arranged downstream of the reservoir and switchable from a closed condition to an open condition to transfer air from the reservoir to the chamber and increase the pressure in the chamber; the compressor, on the other hand, is motorized and operated to transfer air from the chamber to the reservoir and reduce the pressure in the chamber; the assembly is further provided with a one-way valve arranged between the compressor and the reservoir.

### CROSS-REFERENCE TO RELATED APPLICATIONS

This Patent Application claims priority from Italian Patent Application No. 102023000011493 filed on Jun. 6, 2023, the entire disclosure of which is incorporated herein by reference.

### TECHNICAL FIELD

The present invention concerns a vehicle wheel provided with an assembly for adjusting air pressure inside the tire thereof.

In particular, the present invention refers to an assembly having a battery to supply electric power, a motorized compressor, and a regulating valve which is controlled so as to manage the air flows between the compressor and the air chamber defined by the tire.

### PRIOR ART

To adjust the pressure inside tires, solutions are known with a centralized architecture on board the vehicle, having one single reservoir and one single compressor, controlled by a control unit to be activated and introduce compressed air into said reservoir. The reservoir is connected to the wheels by means of respective ducts provided with valves, which are also controlled by the above-mentioned control unit to regulate the compressed air flow: said valves are switched to determine inflation or to determine the discharge of air from the respective tire towards the outside.

Furthermore, another valve pneumatically connects the compressor to the reservoir so that the two components can be isolated when required.

With respect to this type of centralized solution, it is preferable to adopt inflation and deflation systems that are arranged directly on board the wheel in order to reduce the number of components, reduce the overall dimensions on board the vehicle and avoid the passage of compressed air between a fixed part, namely the vehicle body, to a rotating part, namely the wheel.

In the context of these decentralized solutions, document EP0621144 discloses an example in which a two-way compressor is provided on board the wheel and transfers air between the air chamber in the tire and an additional annular chamber, integrated in the wheel rim and defining a reservoir for storing the air. Another example disclosed by EP0621144, namely the one in FIG. 2, entails the use of a one-way compressor and an additional pneumatic line, which connects the air chamber of the tire to the annular reservoir integrated in the rim, in parallel with the compressor. A valve then controls the passage of the air in said line to inflate the tire. In both these solutions, to adjust the pressure in the tire, the air is exchanged between the air chamber and the reservoir integrated in the rim, without contaminating the external air.

However, the pressure in the reservoir integrated in the rim, although greater than the pressure in the air chamber for inflating the latter, is relatively low.

The need is therefore felt to improve the solution shown in FIG. 2 of EP0621144, so that it can be used also with relatively high pressures, thus reducing the volume of the reservoir carried by the rim and therefore the overall dimensions thereof.

The object of the invention is to meet the above-mentioned need, preferably in a simple and/or effective and/or inexpensive manner.

### SUMMARY OF THE INVENTION

The above-mentioned object is achieved by a vehicle wheel as defined in claim 1.

The dependent claims define particular embodiments of the invention.

### BRIEF DESCRIPTION OF THE DRAWINGS

Below, for a better understanding of the present invention, preferred embodiments will be described by way of non-limiting example, with reference to the attached drawings, in which:

FIG. 1 illustrates, in perspective and with parts removed for clarity, a vehicle wheel according to a preferred embodiment of the present invention;

FIG. 2 is a view in a radial direction of the wheel of FIG. 1;

FIGS. 3 and 4 are diagrams relative to the operation of an assembly provided on board the wheel, to adjust the air pressure in said wheel, according to the present invention; and

FIG. 5 is a pneumatic diagram of the assembly for adjusting the air pressure according to the present invention.

### DETAILED DISCLOSURE OF PREFERRED EMBODIMENTS OF THE INVENTION

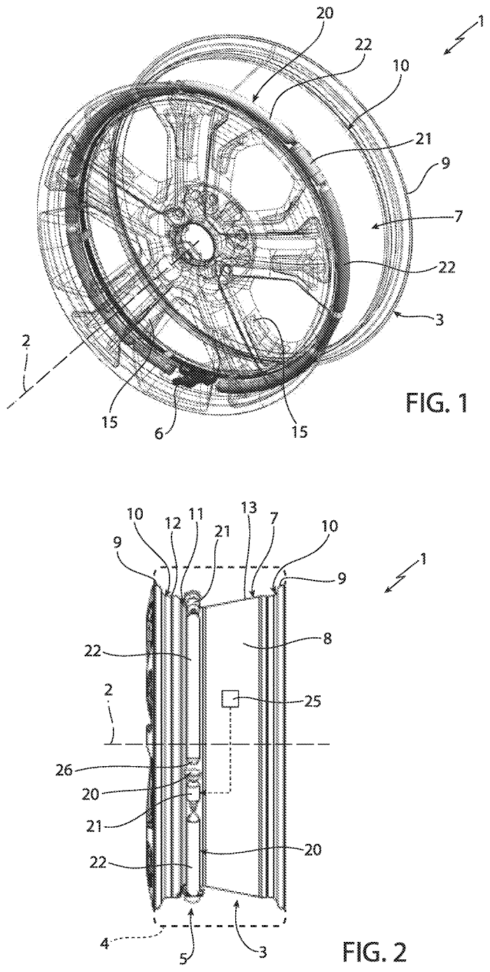

In FIG. 1, the reference number 1 indicates, overall, a vehicle wheel, partially illustrated.

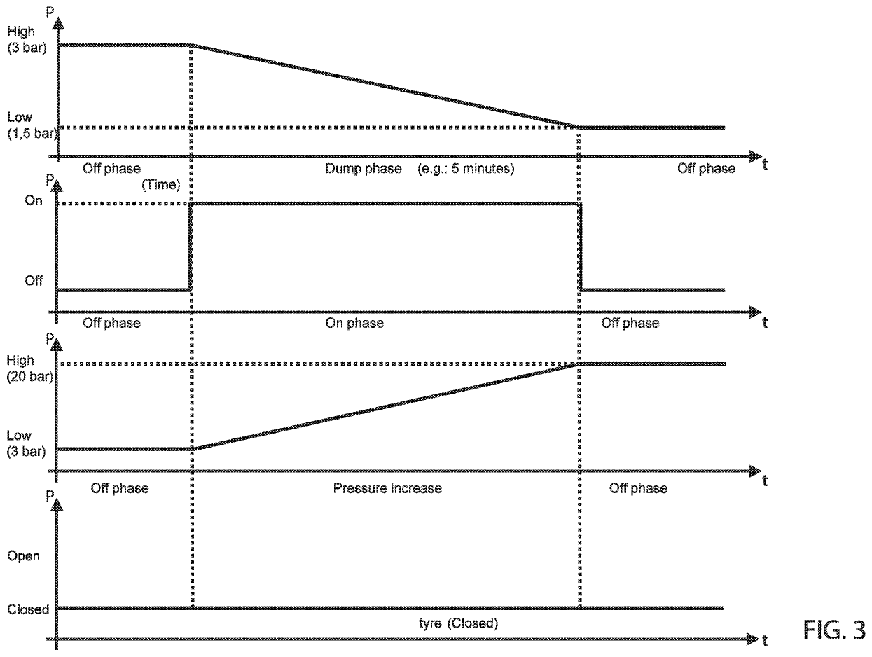

With reference to FIG. 2, the wheel 1 has an axis 2 coinciding, in use, with its axis of rotation, and comprises a rim 3 and a tire 4 (illustrated by a broken line and in a simplified manner) fitted on the rim 3 so as to define, together with the latter, a chamber 5 which is filled with air and can be pressurized from the outside via a valve 6 (FIG. 1). The valve 6, of known type, is generally carried in a fixed relative position by the rim 3.

In particular, the rim 3 has an outer annular wall 7, which radially delimits the chamber 5 and is shaped so as to comprise an intermediate portion 8 and two shoulders 9 arranged at the opposite axial ends of the rim 3. Such shoulders 9 protrude radially outwards with respect to the intermediate portion 8; furthermore, at the shoulders 9, the wall 7 defines two concave areas 10 which are shaped so that they can couple, in a sealed manner, the beads of the tire 4, according to forms and techniques which are known and not described in detail. Furthermore, again according to configurations already known, the intermediate portion 8 of the wall 7 is shaped so as to define an annular channel 11, forming part of the chamber 5 and connected to the areas 10 by means of respective portions 12 and 13 of the wall 7. In particular, the portion 13 has a flared shape, for example a frustoconical shape, which diverges from the channel 11 towards the corresponding axial end of the rim 3; furthermore, more in particular, the portion 12 has an axial extension smaller than that of the portion 13; in use, the portion 13 axially faces towards the body of the vehicle on which the wheel 1 is mounted, while the portion 12 axially faces towards the outside of the vehicle, namely towards an axial end of the rim 3 provided with spokes 15 (FIG. 1).

The wheel 1 further comprises an assembly 20 for automatically adjusting the pressure in the chamber 5, for example to maintain it within a predefined setpoint range and/or to maintain it as close as possible to a predefined setpoint value during use (namely during the vehicle journeys).

Therefore, the assembly 20 is carried on board the wheel 1 and rotates together with the rim 3 around the axis 2 during use.

The assembly 20 comprises at least one motorized compressor 21, at least one reservoir 22 defining at least one chamber with substantially fixed volume, separated from the chamber 5 and from the external environment; at least one battery 24 to supply electric power to the electric motor of the compressor 21; and a microprocessor 25 (schematically illustrated), which controls such electric motor in response to control signals emitted in wireless mode by an emitter (not illustrated) arranged in a fixed position on board the vehicle and/or in response to operations carried out by a control strategy stored in a memory forming part of the same microprocessor 25.

This architecture is therefore of decentralized type, since the assembly 20 is mounted on each of the wheels of the vehicle and is without pneumatic connections and/or electric connections with the fixed part of the vehicle.

The microprocessor 25 is configured so as to operate the motor of the compressor 21 and therefore activate the latter, for example in response to a control signal and/or a reference signal (setpoint) provided by the vehicle dashboard, to send pressurized air from the chamber 5 to the reservoir 22, and not vice versa.

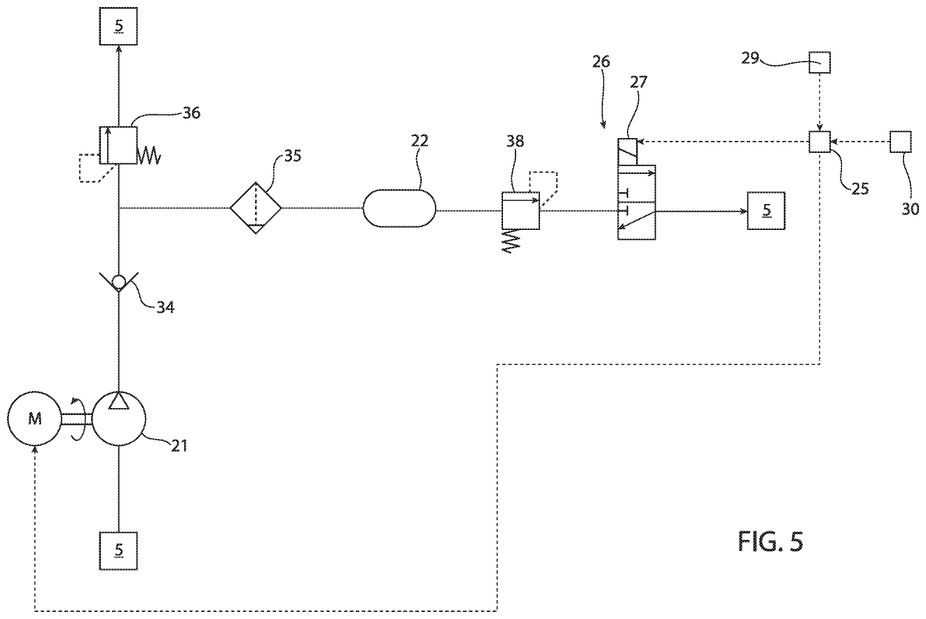

According to one embodiment of the present invention, in fact, the compressor 21 is one-way, namely it is built and mounted so that it can convey a flow of air in one single direction (from the chamber 5 to the reservoir 22). With reference to FIG. 5, the assembly 20 further comprises a valve assembly 26 provided with a solenoid valve 27 which switches, under the control of the microprocessor 25, between a closed configuration and an open configuration in order to allow an air flow from the reservoir 22 to the chamber 5, namely in the opposite direction to the one set by the compressor 21.

Preferably, the microprocessor 25 is configured so as to verify also the air temperature inside the chamber 5, by means of at least one temperature sensor 29 (schematically illustrated), connected in wireless or wired mode to communicate with such microprocessor 25, or integrated in the microprocessor 25, for any correction of the pressure of the air to be introduced/discharged and/or any correction of the setpoint values, according to the temperature detected.

Furthermore, the microprocessor 25 is connected, in wireless or wired mode, to communicate with at least one pressure sensor 30 mounted on the wheel 1. The pressure sensor 30 can be of known type, usually called TPMS, usually installed in the area of the valve 6. In other words, the microprocessor 25 interacts with the sensor 30 to receive detection of the pressure values inside the chamber 5.

The control logics implemented in the microprocessor 25, and/or control signals coming from a fixed control unit, on board the vehicle, are configured so as to inflate and deflate the chamber 5, namely adjust the air pressure inside it, preferably with air quantities/pressures such as to optimize adherence to the ground during use, also according to the type of ground or according to a command by the driver indicative of said type (for example, on mud or on sand it is expedient to reduce the pressure, whereas on asphalt the pressure should be higher to reduce rolling resistance).

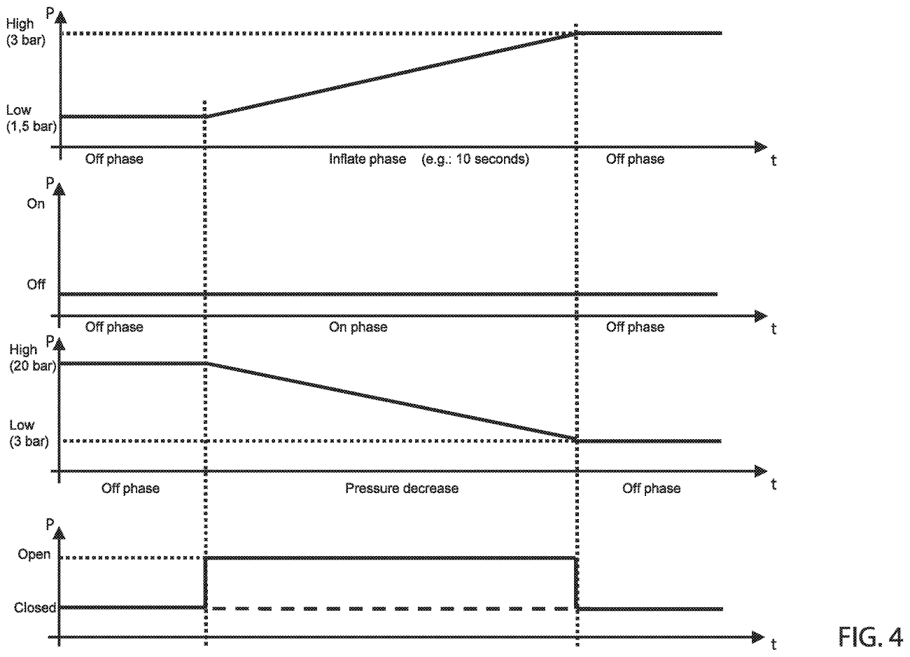

As mentioned above, the air present in the chamber 5, previously introduced from the outside through the valve 6, is pumped from the compressor 21 and transferred into the reservoir 22 so as to reduce the pressure, namely to deflate the tire 4, as shown in FIG. 3.

Analogously, by controlling the solenoid valve 27, an air flow is permitted from the reservoir 22 (at higher pressure) towards the chamber 5 (at lower pressure), and therefore the pressure in the chamber 5 increases: in other words, the tire 4 is inflated, as shown in FIG. 4.

Preferably, the microprocessor 25 is configured with appropriate control algorithms to carry out diagnoses of the whole assembly 20 and transmit, to a control unit on board the vehicle (and then to the dashboard of the passenger compartment), information concerning possible malfunctions and/or information regarding the adjustment steps and stand-by steps between two consecutive adjustments.

The assembly 20 further comprises a system (not illustrated) for recharging the battery 24. In particular, such system is of the induction type and/or is arranged in the area of an outer surface of the wheel 1, to be coupled to the domestic electric power supply, or to a power supply device of the vehicle (for example a cigarette lighter), only with the vehicle at a standstill. Other recharging systems can be provided, however, for example exploiting the rotation of the wheel 1 to generate energy for the battery 24.

If the vehicle is provided with a traditional kit for repairing the tire 4 in the event of a puncture, the components of the assembly 20 must be appropriately chosen so as to be compatible with the chemical products (for example, a mixture of water, latex and ethylene glycol) used in such repair kits.

With reference to the graphs of FIGS. 3 and 4, mentioned above, the pressure in the reservoir 22 increases more than the pressure in the chamber 5 decreases, given the same quantity of air in and out respectively, since the volumes in the reservoir 22 are smaller than that of the chamber 5, and the pressure in the reservoir 22 is much higher than that in the chamber 5.

FIG. 3 shows what happens during deflation: in the first graph starting from the top, it can be seen that the pressure of the chamber 5 drops, for example from 3 bar to 1.5 bar, while the pressure in the reservoir 22 (third graph) increases, for example from 3 bar to 20 bar, namely to a relatively high value. This occurs when the compressor 21 is operated (second graph), as mentioned above. At the same time, the solenoid valve 27 remains in an inactive condition, namely closed (fourth graph). Preferably, therefore, the air compressed by the compressor 21 arrives in the reservoir 22 without switching any valve, but only operating the compressor 21.

With reference again to FIG. 5, according to one embodiment of the present invention, the assembly 20 comprises a one-way valve or check valve 34 arranged downstream of the compressor 21 to prevent refluxes of compressed air from the reservoir 22 towards said outlet, particularly in the case of overpressures in said reservoir 22. If necessary, the valve 34 can be integrated directly in the compressor 21, at the outlet thereof, or can be a separate component, arranged between the outlet of the compressor 21 and the reservoir 22.

Furthermore, preferably, the assembly 20 comprises a condensate separator 35 (for example a dryer), arranged preferably between the outlet of the compressor 21 and the reservoir 22 (for example between the valve 34 and the reservoir 22). The condensate separator 35 allows humidity to be removed from the compressed air flow sent to the reservoir 22: the condensate accumulated can be removed manually, in particular during replacement of the tire 4.

Furthermore, according to a preferred embodiment of the present invention, the assembly 20 comprises a safety valve (or pressure limiting valve) 36, which communicates with the outlet of the compressor 21, through the valve 34, and with the inlet of the reservoir 22 (through any separator 35): the valve 36 is normally closed and has a pneumatic pilot control to automatically open said valve if the pressure of the air supplied from the compressor 21 to the reservoir 22 arrives at, and/or exceeds, a threshold value or calibration value. The outlet of the valve 36 communicates permanently with the chamber 5, hence it discharges the excess air again into the chamber 5 in the event of overpressures in the reservoir 22. Said excess air does not go towards the compressor 21 due to the valve 34. In particular, the above-mentioned threshold value is fixed, namely the calibration of the valve 36 cannot be varied. Preferably, it is a value above 40 bar; for example it is a value equal to approximately 60 bar.

The solenoid valve 27 is interposed between the reservoir 22 and the chamber 5, communicates with the latter in a permanent manner, is normally closed, and opens in response to the command of the microprocessor 25 (fourth graph of FIG. 4, starting from the top) to inflate the tire 4 (first graph of FIG. 4) with the pressurized air stored in the reservoir 22.

Preferably, the solenoid valve 27 is of proportional type, to perform a throttling function and reduce the pressure on the air flow that crosses it according to the command signal.

During the inflation, as shown in the first graph from the top of FIG. 4, it can be seen that the pressure of the chamber 5, after switching to opening of the valve 27, increases to the desired setpoint value, for example 3 bar, due to the flow coming from the reservoir 22. At the same time, the compressor 21 remains deactivated (second graph of FIG. 4) and the pressure of the reservoir 22 (third graph) drops, for example from 20 bar to 3 bar.

With reference to FIG. 5, preferably, the valve assembly 26 comprises a pressure reducing valve 38 arranged between the solenoid valve 27 and the outlet of the reservoir 22.

The valve 38 is a mechanical pressure reducing valve, normally open. In particular, it is pneumatically controlled to close by means of a pressure signal taken downstream of 41 the valve 38 (namely it is controlled to close by means of the pressure between the valves 38 and 27) and, by automatically partially closing, adjusts the air flow so that the downstream pressure does not exceed the preset calibration value.

For Example, the calibration value of the valve 38 is approximately 6 bar.

When the valve 27 is closed, inside the pneumatic line that connects the outlet of the valve 38 to the inlet of the valve 27 a pressure equal to the calibration value of the valve 38 remains, due to the automatic adjustment carried out by the latter. Therefore, when the valve 27 opens, it encounters a pressure difference that starts from said calibration value, and not from the pressure value of the reservoir 22.

In this way, the pressure difference between the reservoir 22 and the chamber 5 during inflation of the tire 4 can be shared between the two valves 38 and 27.

In particular, the calibration value is set so as to be below or equal to a maximum permitted value established at the design stage for the pressure in the tire 4. In this way, the valve 38 also performs a safety function in the event of a malfunction of the valve 27 causing it to open unexpectedly: in this case, the valve 38 automatically fully closes when the pressure downstream (namely in the chamber 5) reaches the calibration value, to prevent the above-mentioned maximum permitted value from being exceeded.

From the above, the advantages of the wheel 1 according to the invention are evident.

In particular, the assembly 20 includes pneumatic valves (34, 36, 38) that allow the use of relatively high pressures in the reservoir 22 in extreme safety, hence it is possible to use small reservoirs 22.

Moreover, the assembly 20 integrates a condensate separator 35 that reduces malfunctioning risks.

Other advantages are evident to a person skilled in the art based on the above description.

Lastly, it is clear that modifications and variations that do not depart from the protective scope defined by the attached claims can be made to the wheel 1 according to the present invention.

In particular, the condensate separator 35 could be absent, of different type or in a different position with respect to what is indicated above by way of example; and/or the calibration values could be different from the values indicated above by way of example.

1. A vehicle wheel comprising:
a rim ,
a tire defining, together with said rim, a chamber which is filled with air and can be pressurized;
an assembly for adjusting air pressure in said chamber, the assembly comprising:
a) at least one compressor having:
(1) a first inlet, pneumatically connected to said chamber; and
(2) a first outlet;
b) at least one reservoir carried by said rim and having:
(1) a second inlet pneumatically connected to said first outlet for receiving compressed air from said compressor and
(2) a second outlet;
c) at least one battery to supply electric power;
d) at least one solenoid valve arranged between said second outlet and said chamber and switchable from a closed condition to an open condition to transfer air from said reservoir to said chamber and increase the pressure in said chamber; said compressor being motorized and being operated to transfer air from said chamber to said reservoir and reduce the pressure in said chamber
wherein said assembly comprises a one-way valve arranged between said first outlet and said second inlet.

2. The vehicle wheel according to claim 1, wherein said assembly further comprises a pressure limiting valve arranged between said one-way valve and said chamber, in parallel with said reservoir.

3. The vehicle wheel according to claim 2, wherein said pressure limiting valve has a pneumatic pilot control, defined by a pressure present between said one-way valve and said pressure limiting valve.

4. The vehicle wheel according to claim 1, any wherein said one-way valve is integrated in said compressor.

5. The vehicle wheel according to claim 1, any wherein said assembly comprises a condensate separator.

6. The vehicle wheel according to claim 5, wherein said condensate separator is arranged between said one-way valve and said second inlet.

7. The vehicle wheel according to claim 1, any one of the preceding claims, wherein said assembly comprises a pressure reducing valve arranged between said second outlet and said solenoid valve.

8. The vehicle wheel according to claim 7, wherein said pressure reducing valve has a pneumatic pilot control, defined by a pressure present between said solenoid valve and said pressure reducing valve.

9. The vehicle wheel according to claim 1, wherein said solenoid valve is a proportional valve.
